(19) United States
(12) Patent Application Publication
(10) Pub. No.: US 2015/0042902 A1
(43) Pub. Date: Feb. 12, 2015

(54) LIGHTING DEVICE AND DISPLAY SYSTEM INCLUDING LIGHTING DEVICE

(71) Applicant: SHARP KABUSHIKI KAISHA, Osaka-shi, Osaka (JP)

(72) Inventors: Hiromi Enomoto, Osaka-shi (JP); Nobuhiko Akanuma, Osaka-shi (JP); Yuhsuke Nii, Osaka-shi (JP); Shinji Tomokawa, Osaka-shi (JP)

(73) Assignee: SHARP KABUSHIKI KAISHA, Osaka-shi, Osaka (JP)

(21) Appl. No.: 14/344,729

(22) PCT Filed: Sep. 11, 2012
(86) PCT No.: PCT/JP2012/005747

§ 371 Date: Mar. 13, 2014

(30) Foreign Application Priority Data
Sep. 15, 2011 (JP) 2011-202344

(51) Int. Cl. F21V 8/00; G02F 1/1333

(52) U.S. Cl. CPC G02B 6/005; G02F 1/13338; G02B 6/0081
USPC 349/12; 362/606

(57) ABSTRACT

A lighting device includes a light source; a light guide plate including a side surface, on which light of the light source is incident, and a front surface extending perpendicular to the side surface; and a plurality of light emitting regions disposed on the front surface to be spaced apart from one another, and having optical patterns for emitting light from an inside of the light guide plate.

### TECHNICAL FIELD

The present invention relates to lighting devices and display systems including the lighting devices.

### BACKGROUND ART

In recent years, demand for thin display systems (flat panel displays) such as liquid crystal display systems is increasing, which are widely applied for mobile devices such as smart phones and mobile phones.

For example, a liquid crystal display system includes a back light unit, which is a lighting device, and a liquid crystal display panel disposed to face the back light unit. In recent years, liquid crystal display panels include not only back light units but also what are called touch panels, etc. are layered to increase the functions of the display systems.

In general, what are called edge-light type back light units are known, each of which includes a light source such as a light emitting diode (LED) and a light guide plate, on which light of the light source is incident from its side surface. The light guide plate has a light emitting surface extending perpendicular to the side surface, on which the light is incident. In the back light unit, the light incident on the light guide plate from the side surface is repeatedly reflected and diffused inside the light guide plate to be emitted as light with uniform luminance from the entire light emitting surface.

On the other hand, Patent Document 1 shows a back light unit including a case with a light emitting surface, a plurality of LEDs provided in the case and arranged in a matrix to face the light emitting surface. The light of the LEDs is once reflected to the side opposite to the light emitting surface, and then the reflected light is reflected and diffused inside the case to emit light with uniform luminance from the light emitting surface.

### CITATION LIST

### Patent Document

PATENT DOCUMENT 1: Japanese Unexamined Patent Publication No. 2007-516561

### SUMMARY OF THE INVENTION

### Technical Problem

The present inventors study lighting a plurality of separated regions using a back light unit. For example, a transparent substrate with a light shielding film is disposed to face the back light unit. In the light shielding film, a plurality of openings are formed to be spaced apart from each other. As a result, the light transmitted by the openings lights the plurality of regions.

However, in recent years, as reduction in the thickness of display systems has been increasingly demanded, reduction in the thickness of back light units forming the display systems has also been demanded. Reducing the thickness of a light guide plate in an edge-light type back light is thus considered. If the thickness of the light guide plate is reduced, light cannot be sufficiently reflected and diffused inside the light guide plate, and it becomes difficult to emit light with uniform luminance from a light emitting surface. As a result, when a plurality of regions are lighted, the luminance of the light in the regions may become non-uniform. In addition, part of the light emitted from the light guide plate is shielded by a light shielding film and not efficiently utilized. Thus, the luminance of the light in the plurality of regions is difficult to sufficiently improve.

On the other hand, as in Patent Document 1, arranging the plurality of LEDs to face the light emitting surface of the back light unit is considered. Specifically, the LEDs are arranged to face the plurality of regions, thereby lightning the regions using light with uniform and high luminance. In this case, however, the LEDs themselves have a relatively great thickness, the thickness of the back light unit, which is a lighting device, is extremely difficult to reduce.

The present invention was made in view of the problems. It is an objective of the present invention to reduce the thickness of a lighting device which lights a plurality of regions, while improving the luminance of the light in the regions as much as possible.

### Solution to the Problem

In order to achieve the objective, a lighting device according to the present invention includes a light source; a light guide plate including a side surface, on which light of the light source is incident, and a front surface extending perpendicular to the side surface; and a plurality of light emitting regions disposed on the front surface to be spaced apart from one another, and having optical patterns for emitting light from an inside of the light guide plate.

With this structure, the plurality of light emitting regions with the optical patterns are formed on the front surface of the light guide plate to be separated from one another. As a result, the light incident on the light guide plate from the side surface of the light guide plate is efficiently emitted from the light emitting regions. Thus, even when the thickness of the light guide plate is reduced, the plurality of regions corresponding to the light emitting regions are reliably lighted, and the luminance of the light in the regions improves.

A flexible substrate disposed on the light guide plate at a side opposite to the front surface to control the light source may be included. A reflection layer reflecting toward the light guide plate, light emitted from the light guide plate to the flexible substrate may be printed on the flexible substrate.

With this structure, the light emitted from the light guide plate to the flexible substrate is reflected by the reflection layer of the flexible substrate to be incident on the light guide plate again and emitted from the irradiated regions, thereby efficiently utilizing the light of the light source. In addition, the reflection layer is directly printed on the flexible substrate. There is thus no need to provide an extra reflection material for reflecting the light of the light guide plate, thereby further reducing the thickness of the lighting device.

The light guide plate may be formed like a band. The light source may be disposed at each longitudinal end of the band-like light guide plate.

With this structure, the light of the light source is incident on the light guide plate from the both sides of the band-like light guide plate. Thus, even when the thickness of the light guide plate is reduced, sufficient light is incident on the light guide plate to further improve the luminance of the light in the light emitting regions.

A display system according to the present invention includes a display panel; a display section performing display with the display panel; a non-display section formed around the display section; a substrate stacked on the display panel, and including a touch panel and a control section formed in the non-display section to input instructions to the touch panel; and a lighting device for supplying illumination light to the control section to light the control section. The lighting device includes a light source, a light guide plate including a side surface, on which light of the light source is incident, and a front surface extending perpendicular to the side surface; and a plurality of light emitting regions disposed on the front surface to be spaced apart from one another, and having optical patterns for emitting light from an inside of the light guide plate.

With this structure, the light supplied from the lighting device lights the control section. This facilitates visual recognition of the control section, even when the illuminance is relatively low under the use environment. As a result, the controllability of the display system largely improves. In addition, the plurality of light emitting regions with the optical patterns are formed on the front surface of the light guide plate to be separated from one another. As a result, the light incident on the light guide plate from the side surface of the light guide plate is efficiently emitted from the light emitting regions. Thus, even when the thickness of the light guide plate of the lighting device is reduced, the plurality of regions corresponding to the light emitting regions are reliably lighted, and the luminance of the light in the regions improves.

The lighting device may further include a flexible substrate disposed on the light guide plate at a side opposite to the front surface to control the light source. A reflection layer reflecting toward the light guide plate, light emitted from the light guide plate to the flexible substrate may be printed on the flexible substrate.

With this structure, the light emitted from the light guide plate to the flexible substrate is reflected by the reflection layer to be incident on the light guide plate again and emitted from the irradiated regions, thereby efficiently utilizing the light of the light source. In addition, the reflection layer is directly printed on the flexible substrate. There is thus no need to provide an extra reflection material for reflecting the light of the light guide plate, thereby further reducing the thickness of the lighting device.

The light guide plate may be formed like a band. The light source may be disposed at each longitudinal end of the band-like light guide plate.

With this structure, even when the thickness of the light guide plate is reduced, sufficient light is incident on the light guide plate to further improve the luminance of the light in the light emitting regions.

### Advantages of the Invention

According to the present invention, the plurality of light emitting regions with optical patterns are formed on the front surface of the light guide plate to be spaced apart from one another. This efficiently emits from the light emitting regions, the light incident on the light guide plate from the side surface of the light guide plate. Therefore, even when the thickness of the light guide plate is reduced, the plurality of regions corresponding to the light emitting region are reliably lighted, and the luminance of the light in the regions improves.

### BRIEF DESCRIPTION OF THE DRAWINGS

FIG. 1 is an oblique drawing of the principal structure of a liquid crystal display system according to a first embodiment.

FIG. 2 is an enlarged cross-sectional view illustrating the side of the liquid crystal display system.

FIG. 3 is an enlarged cross-sectional view illustrating part of FIG. 2.

FIG. 4 is an oblique drawing of the structure of a light source unit according to the first embodiment.

FIG. 5 is a top view illustrating the appearance of the liquid crystal display system.

FIG. 6 is an enlarged front view illustrating the appearance of a light guide plate.

FIG. 7 is a front view illustrating the appearance of the light source unit.

FIG. 8 is an oblique drawing of a cover substrate, a resin film, and a touch panel.

FIG. 9 is an oblique drawing of an adhesive layer attached to the touch panel.

FIG. 10 is an oblique drawing of a second sub-FPC and the cover substrate.

FIG. 11 is an oblique drawing of the second sub-FPC attached to the cover substrate.

FIG. 12 is an oblique drawing of a substrate and a liquid crystal display panel.

FIG. 13 is an oblique drawing of the substrate stacked on the liquid crystal display panel, and a back light unit.

FIG. 14 is an oblique drawing of the substrate stacked on the back light unit.

FIG. 15 is an enlarged oblique drawing of first and fourth extensions connected together.

FIG. 16 is an enlarged oblique drawing of second and third extensions connected together.

FIG. 17 is an oblique drawing of folded extensions.

FIG. 18 is an oblique drawing of the liquid crystal display system with the folded extensions.

FIG. 19 is an oblique drawing of an insulating tape material fixing the extensions.

FIG. 20 is an oblique drawing of the structure of a light source unit according to a second embodiment.

FIG. 21 is an enlarged cross-sectional view illustrating the side of a liquid crystal display system according to a third embodiment.

FIG. 22 is an enlarged cross-sectional view illustrating part of FIG. 21.

### DESCRIPTION OF EMBODIMENTS

Embodiments will be described hereinafter in detail with reference to the drawings. The present invention is not limited to the following embodiments.

### First Embodiment of Invention

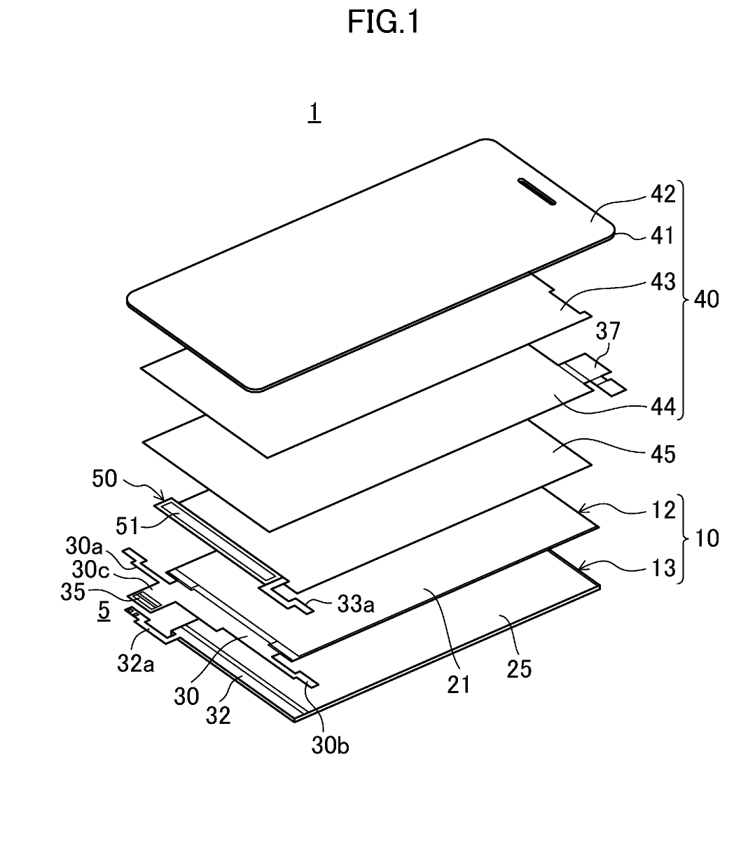

FIGS. 1-19 illustrate a first embodiment of the present invention.

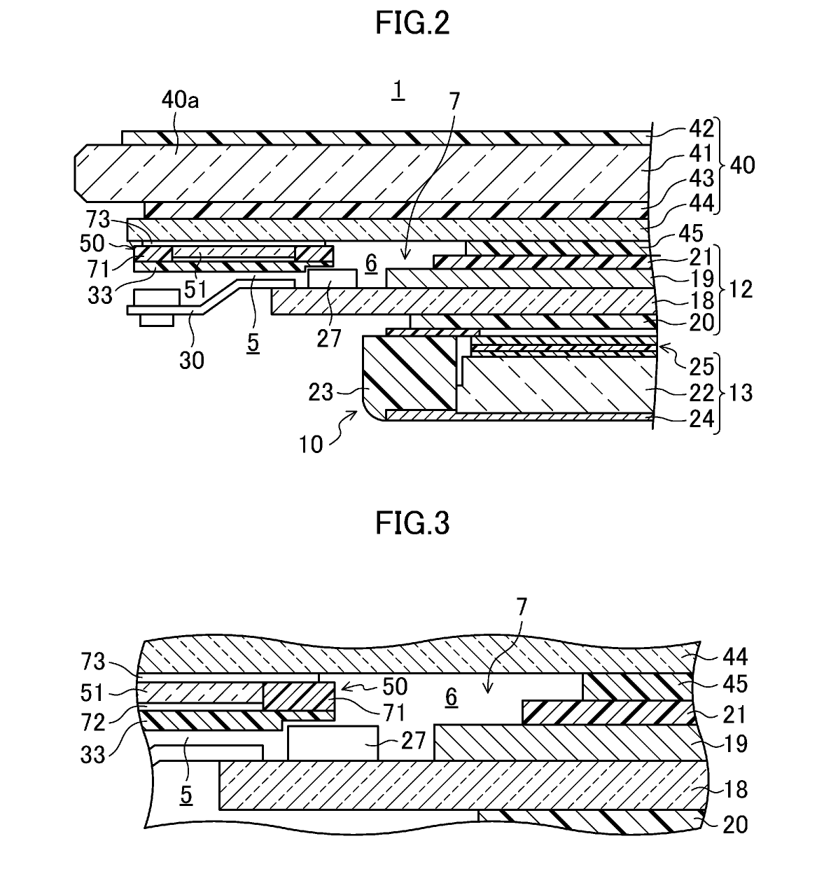

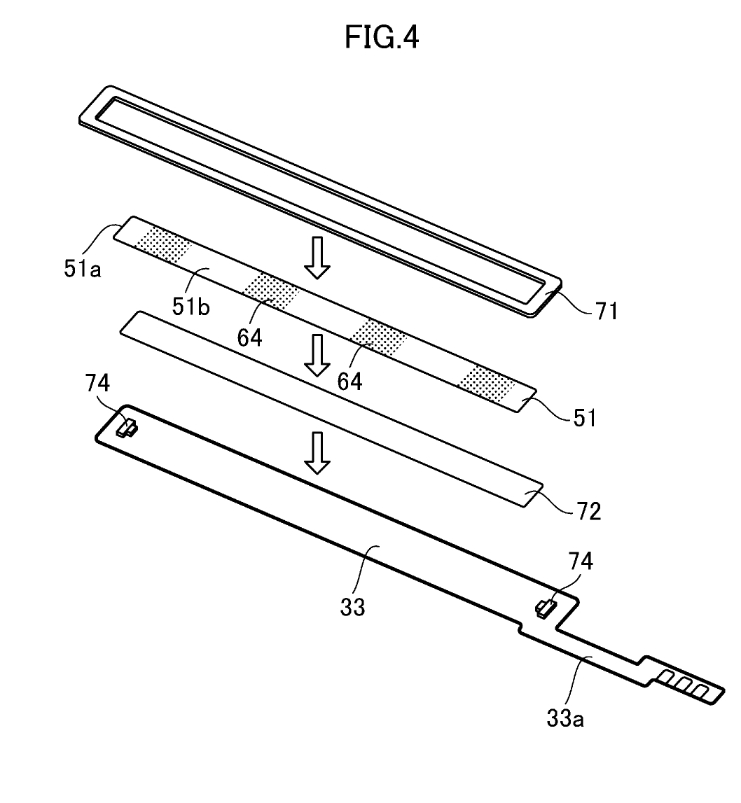

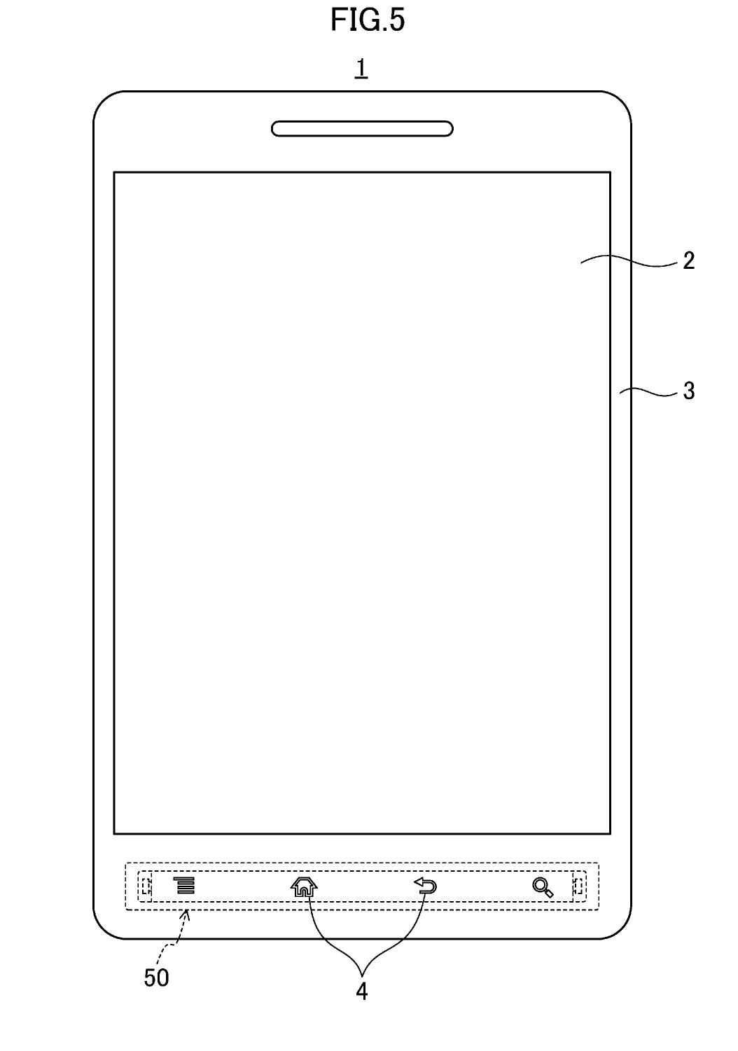

FIG. 1 is an oblique drawing of the principal structure of a liquid crystal display system 1 according to the first embodiment. FIG. 2 is an enlarged cross-sectional view illustrating the side of the liquid crystal display system 1. FIG. 3 is an enlarged cross-sectional view illustrating part of FIG. 2. FIG. 4 is an oblique drawing of the structure of a light source unit 50 according to the first embodiment. FIG. 5 is a top view illustrating the appearance of the liquid crystal display system 1.

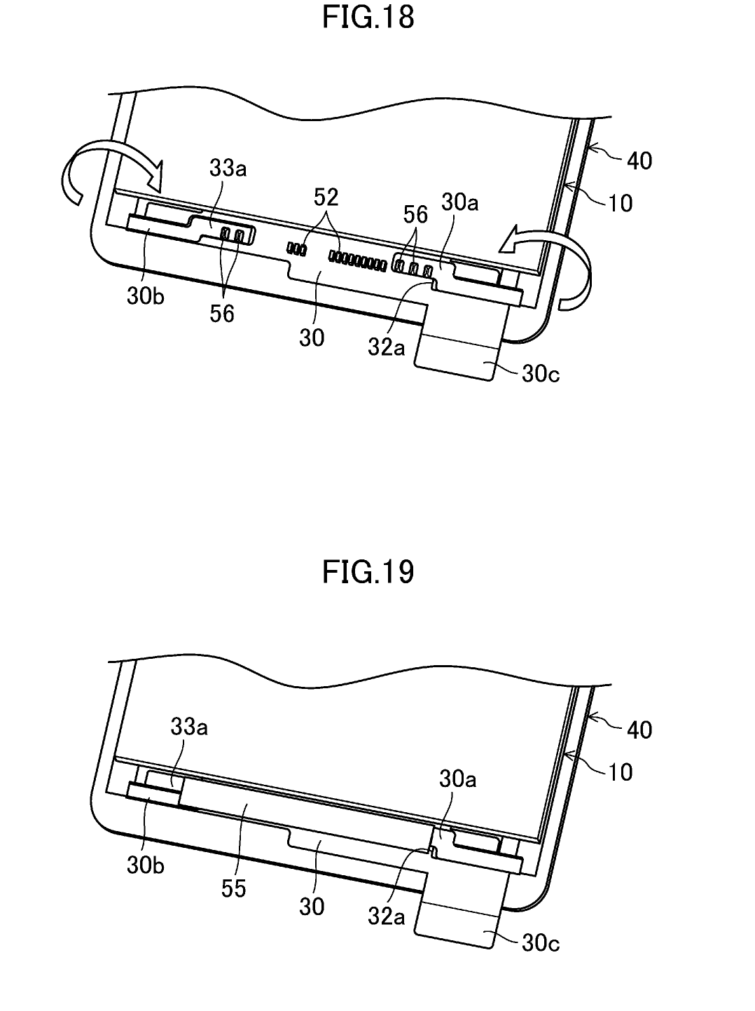

FIG. 17 is an oblique drawing of folded extensions 30a, 30b, 32a, and 33a. FIG. 18 is an oblique drawing of the liquid crystal display system 1 with the folded extensions 30a, 30b, 32a, and 33a. FIG. 19 is an oblique drawing of an insulating tape material 55 fixing the extensions 30a, 30b, 32a, and 33a.

In this embodiment, the liquid crystal display system 1 will be described as an example display system according to the present invention. The liquid crystal display system 1 is, for example, a display system for a smart phone. As shown in FIGS. 1 and 2, the liquid crystal display system 1 includes a layered panel 10 including a liquid crystal display panel 12 as a display panel, and a substrate 40 stacked on the layered panel 10.

As shown in FIG. 5, the liquid crystal display system 1 includes a display section 2 performing display with the liquid crystal display panel 12, and a non-display section 3 formed around the display section 2. As shown in FIG. 2, the substrate 40 is stacked on the liquid crystal display panel 12 with an adhesive layer 45 interposed therebetween. The liquid crystal display system 1 has a step portion 7 including at least the side of the liquid crystal display panel 12 and the side of the adhesive layer 45 such that a space 6 is located in a part between the liquid crystal display panel 12 and the substrate 40.

### Layered Panel

The layered panel 10 includes a plurality of rectangular panels 12 and 13 layered one another such that the short sides of the plurality of panels 12 and 13 extend in the same direction. The plurality of panels 12 and 13 include the liquid crystal display panel 12, and the back light unit 13, which is a lighting device stacked on the liquid crystal display panel 12 to supply light to the display section 2.

As shown in FIG. 1, FPCs 30 and 32, which are flexible substrates, are respectively connected to the short sides of the liquid crystal display panel 12 and the back light unit 13, which are located at one side of the layered panel 10.

The FPCs 30 and 32 include a main FPC 30, which is a single main flexible substrate with a connector 35, and a first sub-FPC 32, which is at least one sub-flexible substrate without connector.

### Liquid Crystal Display Panel

As shown in FIG. 2, the liquid crystal display panel 12 includes a TFT substrate 18 including a plurality of TFTs (not shown) as switching elements, a counter substrate 19 facing the TFT substrate 18, and a liquid crystal layer (not shown) interposed between the TFT substrate 18 and the counter substrate 19. A polarizing plate 20 is attached the TFT substrate 18 at the side opposite to the surface facing the counter substrate 19. On the other hand, a polarizing plate 21 is attached to the counter substrate 19 at the side opposite to the surface facing the TFT substrate 18.

The TFT substrate 18 has a short side region not facing the counter substrate 19. This short side region forms the above-described step portion 7. In this embodiment, the step portion 7 includes the side surface of the TFT substrate 18, the side surface of the counter substrate 19, and the side surface of the adhesive layer 45. A driver IC 27 and the main FPC 30 as circuit parts are connected to the short side region of the TFT substrate 18. The driver IC 27 includes a drive circuit driving and controlling the liquid crystal display panel 12.

As shown in FIG. 1, the main FPC 30 has the first extension 30a and the second extension 30b, which extend outward from the side region 5 of the layered panel 10 along the short side of the liquid crystal display panel 12 at the side region 5.

As shown in FIG. 1, the tops of the extensions 30a and 30b extend along the short sides of the liquid crystal display panel 12 in opposite directions. The extensions 30a and 30b are formed like cranks such that the base end portions of the extensions 30a and 30b are more distant from the side of the layered panel 10 provided with the main FPC 30 than the base end portions.

The main FPC 30 has a tip end 30c projecting along the long sides of the liquid crystal display panel 12 in the side region 5 of the layered panel 10. The tip end 30c includes the connector 35 with a connecting terminal.

### Back Light Unit

As shown in FIG. 2, the back light unit 13 is located on the liquid crystal display panel 12 at the side opposite to the side facing the substrate 40. The back light unit 13 includes a light guide plate 22, which is a rectangular plate, a plurality of LEDs (not shown), which are light sources facing the side surface of the light guide plate 22, a plurality of optical sheets 25 provided on the light guide plate 22 at the side closer to the liquid crystal display panel 12, and a reflection plate 24 provided on the light guide plate 22 at the side opposite to the side facing the optical sheets 25. The light guide plate 22 the LEDs, the optical sheets 25, and the reflection plate 24 are held by a frame 23 made of resin. As such, the back light unit 13 is formed as a whole like a rectangular plate.

The first sub-FPC 32, which is a sub-flexible substrate, is connected to the short side of the back light unit 13. As shown in FIG. 1, the first sub-FPC 32 has the fourth extension 32a extending outward from the side region 5 of the layered panel 10, along the short side of the back light unit 13. The fourth extension 32a overlaps and is electrically connected to the first extension 30a of the main FPC 30 by soldering, etc. As shown in FIGS. 17 and 18, the fourth extension 32a is folded to the side region 5 of the layered panel 10.

### Substrate

As shown in FIG. 1, the substrate 40 includes a cover substrate 41, to which a protection film 42 is attached, and a touch panel 44 attached to the cover substrate 41 with a resin film 43 interposed therebetween. At the touch panel 44, the substrate 40 is attached to the liquid crystal display panel 12 of the layered panel 10 with the adhesive layer 45 interposed therebetween.

The cover substrate 41 is, for example, a glass substrate, etc. An FPC 37 for transmitting control signals etc., to the touch panel 44 is connected to the short side of the touch panel 44 opposite to the side facing the side region 5 of the layered panel 10.

As shown in FIG. 2, the substrate 40 has a side end portion 40a projecting more toward the side region 5 of the layered panel 10 than the layered panel 10. The side end portion 40a includes short side regions of the cover substrate 41 and the touch panel 44.

The substrate 40 includes control sections 4 formed in the non-display section 3 of the liquid crystal display system 1 to input instructions to the touch panel 44. Specifically, a light shielding film (not shown) is formed on the cover substrate 41 at the side end portion 40a. As shown in FIG. 5, a plurality of icons as the control sections 4 are formed on the light shielding film using patterns transmitting light. In this embodiment, for example, four control sections 4 are arranged in the substrate 40 at predetermined intervals.

### Light Source Unit

As shown in FIG. 2, the light source unit 50 as a lighting device according to the present invention is provided at the side end portion 40a of the substrate 40. The light source unit 50 and the back light unit 13 are provided separately and independently. The light source unit 50 is a light source for supplying illumination light to the control sections 4 to light the plurality of the control sections 4. The light source unit 50 is attached to the surface of the touch panel 44, which is opposite to the surface facing the cover substrate 41. At least part of the light source unit 50 is located in the space 6 between the substrate 40 and the liquid crystal display panel 12 to overlap the liquid crystal display panel 12 at the step portion 7.

As shown in FIGS. 3 and 4, the light source unit 50 includes LEDs 74, which are light sources, a light guide plate 51, a frame-like light shielding material 71, and a second sub-FPC 33, which is a flexible substrate for controlling the LEDs 74.

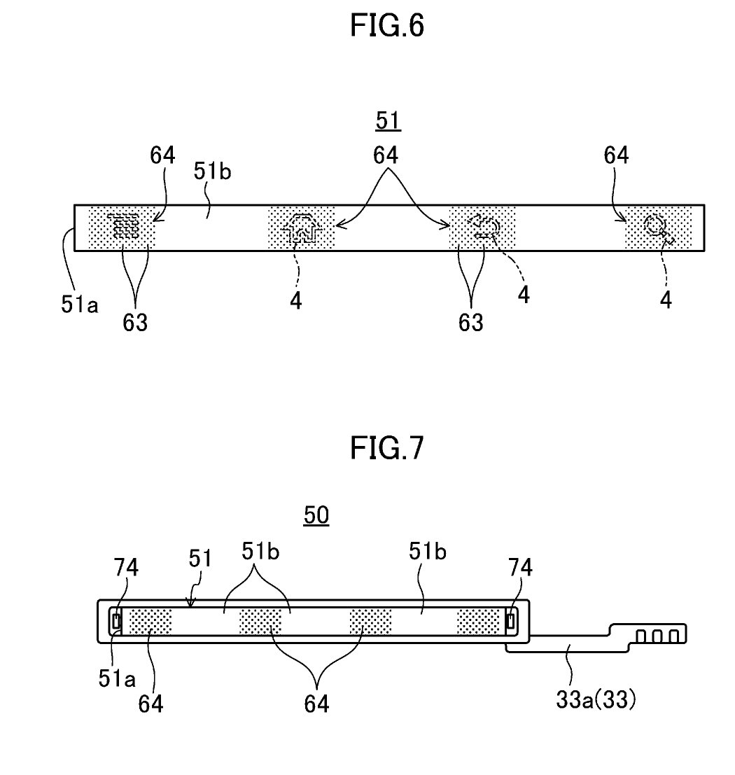

As shown in FIGS. 6 and 7, the light guide plate 51 has a side surface 51a, on which the light of the LEDs 74 is incident, and a front surface 51b extending perpendicular to the side surface 51a. The light shielding material 71 is provided around the light guide plate 51. The second sub-FPC 33 is provided on the light guide plate 51 opposite to the front surface 51b.

The light guide plate 51 is formed like a band, disposed to extend along the short sides of the substrate 40, and attached to the second sub-FPC 33 with a white double-sided tape 72 interposed therebetween, which is a reflection material. The double sided tape 72 is formed by providing adhesive layers on the both surfaces of a white sheet material, and has the same band-like shape as the light guide plate 51. The LEDs 74 are disposed at the both longitudinal ends of the light guide plate 51 to be mounted on the second sub-FPC 33.

The light shielding material 71 is disposed to surround the LEDs 74, the light guide plate 51, and the double-sided tape 72, and attached to the second sub-FPC 33. Then, the light of the LEDs 74 is incident from the light guide plate 51, and diffused inside the light guide plate 51. Part of the light is reflected by the white double-sided tape 72. Illumination light is emitted from the surface of the light guide plate 51 at the side of the substrate 40.

As shown in FIG. 6, the light source unit 50 includes a plurality of light emitting regions 64 provided in the front surface 51b to be spaced apart one another. Each of the regions 64 has an optical pattern 63 for emitting light from the inside of the light guide plate 51. In this embodiment, for example, four light emitting regions 64 are formed on the front surface 51b of the light guide plate 51. No optical pattern 63 is formed between each pair of the light emitting regions 64. As a result, the light guided to the inside of the light guide plate 51 is emitted not from the regions without optical patterns but from the light emitting regions 64 mainly.

While the first sub-FPC 32 is provided at the side of the layered panel 10, the second sub-FPC 33 is provided at the side end portion 40a of the substrate 40. As shown in FIG. 3, the region of the second sub-FPC 33, which faces the driver IC 27 of the liquid crystal display panel 12, has a smaller thickness than the other regions. This avoids the contact between the second sub-FPC 33 and the driver IC 27.

As shown in FIG. 1, the second sub-FPC 33 has the third extension 33a, which is an extension extending outward from the side region 5 of the layered panel 10 along the short sides of the substrate 40 at the side region 5. The third extension 33a overlaps the second extension 30b of the main FPC 30.

As shown in FIGS. 17 and 18, the third extension 33a of the second sub-FPC 33 overlaps and is electrically connected to the second extension 30b of the main FPC 30 by soldering, etc., and folded to the side region 5 of the layered panel 10.

As shown in FIG. 19, the folded first to fourth extensions 30a, 30b, 32a, and 33a are fixed to the main FPC 30 by the insulating tape material 55, which covers the electrical connecting portions 56 soldered etc. in the extensions 30a, 30b, 32a, and 33a, and the elements 52 formed in the main FPC 30.

As such, the folded second and third extensions 30b and 33a, and the folded first and fourth extensions 30a and 32a are arranged such that the extensions 30a, 30b, 32a, and 33a as a whole overlap the side end portion 40a of the substrate 40. That is, all of the extensions 30a, 30b, 32a, and 33a are efficiently arranged in the space overlapping the side end portion 40a of the substrate 40 in the side region 5 of the layered panel 10.

Therefore, even when the number of the FPCs increases with an increase in the number of the panels, the thickness of the liquid crystal display system 1 as a whole can be reduced. In addition, the plurality of the FPCs 30 and 32 are directly electrically connected together in the first and fourth extensions 30a and 32a without interposing any connector, thereby reducing the number of the connectors. As a result, the space and costs for the connectors can be largely reduced.

As described above, the liquid crystal display system 1 receives and outputs a plurality of types of control signals from the connector 35 of the main FPC 30, thereby controlling all of the back light unit 13, the liquid crystal display panel 12, and the light source unit 50.

Specifically, the control signals etc., are supplied to the back light unit 13 from the connector 35 via the main FPC 30 and the first sub-FPC 32. The control signals etc., are supplied to the liquid crystal display panel 12 from the connector 35 via the main FPC 30. Furthermore, the control signals etc., are supplied to the light source unit 50 from the connector 35 via the main FPC 30 and the second sub-FPC 33.

As such, the light source unit 50 is controlled separately and independently from the back light unit 13, and supplies light to the icons, which are the control sections 4 formed on the side end portion 40a of the substrate 40, thereby lighting the control sections 4. When the user touches the lighting control sections 4, the touch positions are detected by the touch panel 44.

### Manufacturing Method

A method of manufacturing the liquid crystal display system 1 will be described.

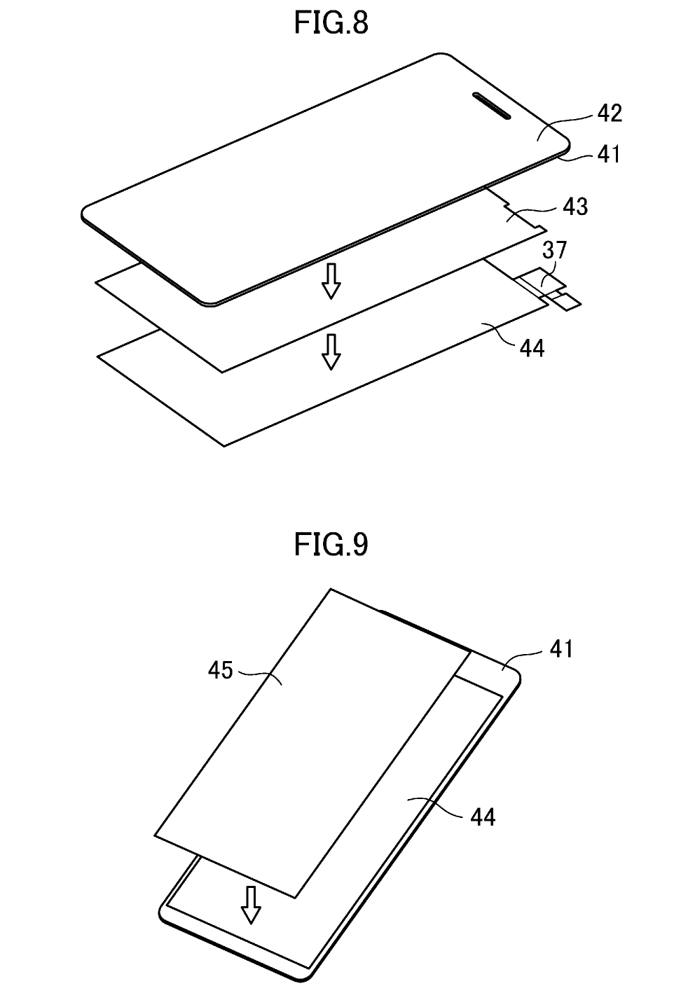

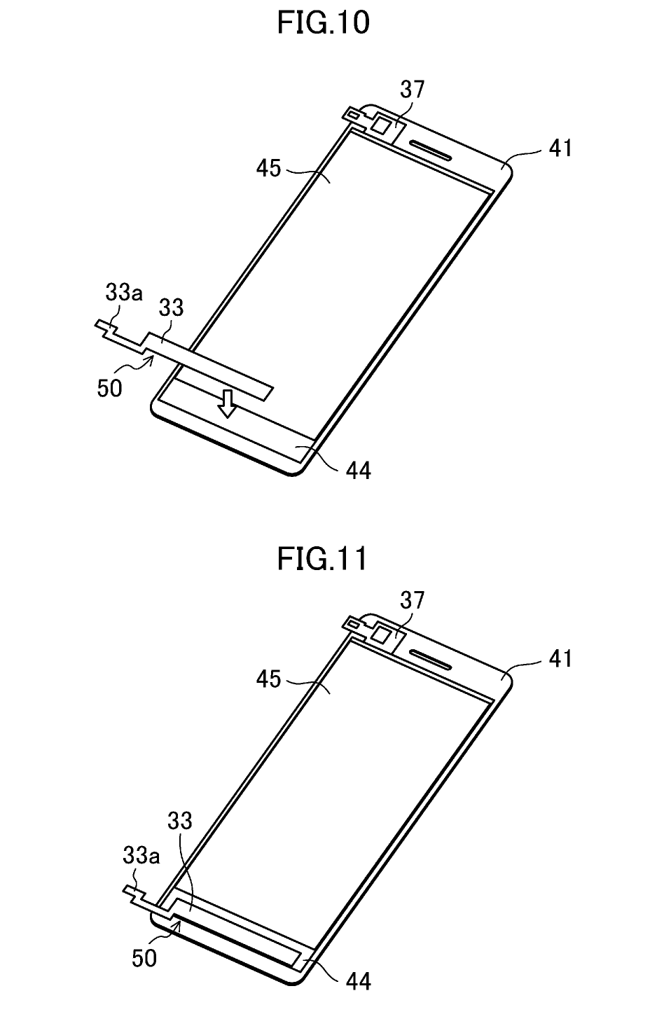

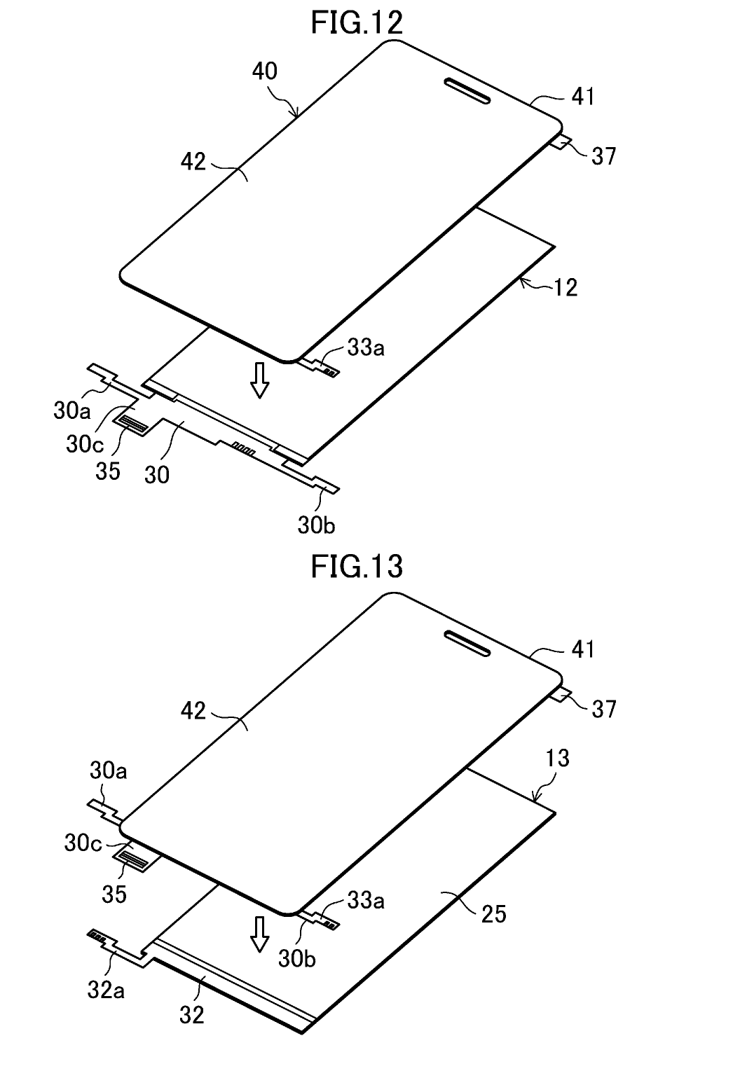

FIG. 8 is an oblique drawing of the cover substrate 41, the resin film 43, and the touch panel 44. FIG. 9 is an oblique drawing of the adhesive layer 45 attached to the touch panel 44. FIG. 10 is an oblique drawing of the second sub-FPC 33 and the cover substrate 41. FIG. 11 is an oblique drawing of the second sub-FPC 33 attached to the cover substrate 41. FIG. 12 is an oblique drawing of the substrate 40 and the liquid crystal display panel 12.

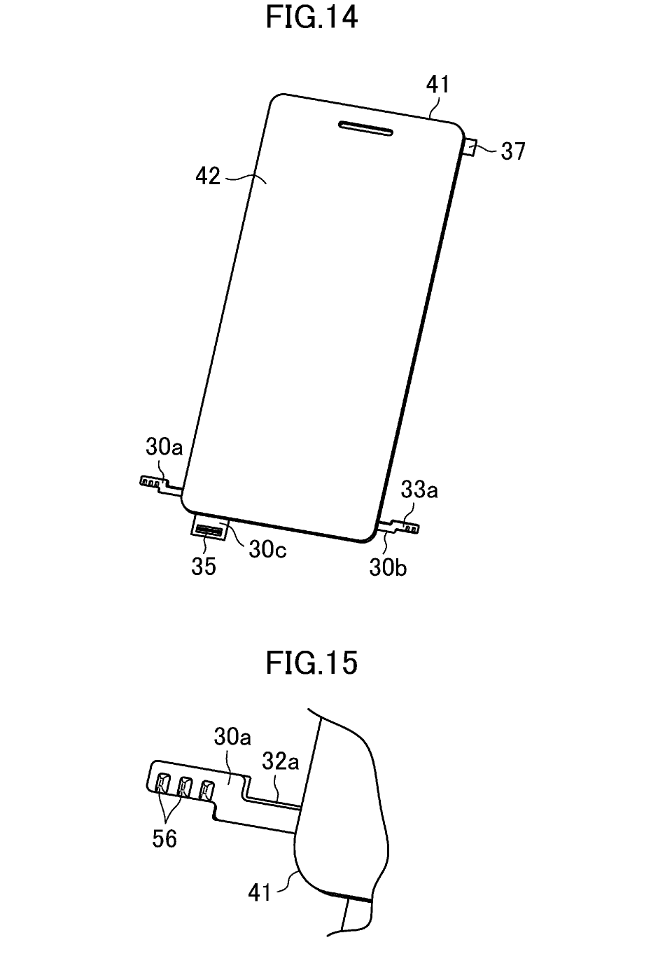

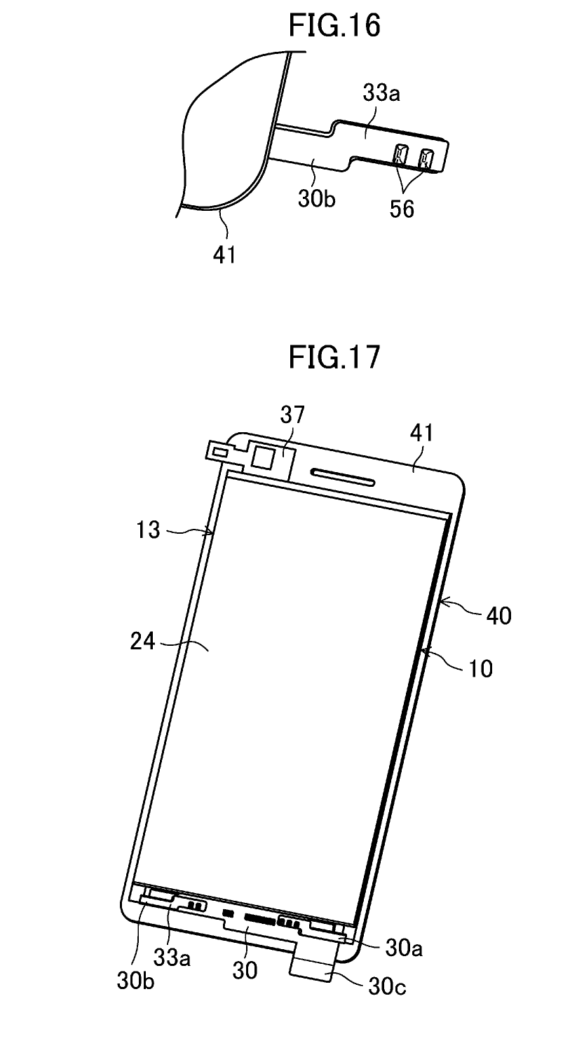

FIG. 13 is an oblique drawing of the substrate 40 stacked on the liquid crystal display panel 12, and the back light unit 13. FIG. 14 is an oblique drawing of the substrate 40 stacked on the back light unit 13. FIG. 15 is an enlarged oblique drawing of the first and fourth extensions 30a and 32a connected together. FIG. 16 is an enlarged oblique drawing of the second and third extensions 30b and 33a connected together.

First, as shown in FIG. 8, the cover substrate 41 is attached to the touch panel 44 with the resin film 43 interposed therebetween. The protection film 42 is attached to the cover substrate 41. Then, as shown in FIG. 9, the adhesive layer 45 is attached to the touch panel, which is attached to the cover substrate 41. The adhesive layer 45 is shorter than the touch panel 44 along its long sides. Thus, as shown in FIG. 10, one short side region of the touch panel 44 is exposed from the adhesive layer 45 in the region, which serves as the side end portion 40a of the substrate 40.

On the other hand, as shown in FIG. 4, the light guide plate 51 is attached to the second sub-FPC 33 mounted with the LEDs 74 with the white double sided tape 72 interposed therebetween. For example, four light emitting regions 64 are formed in the light guide plate 51 by forming the optical patterns 63 on the front surface 51b in advance.

The rectangular frame-like light shielding material 71 is attached to the second sub-FPC 33 to surround the LEDs 74, the light guide plate 51, and the double-sided tape 72. As shown in FIGS. 2 and 11, the light source unit 50 is attached to the touch panel 44, which is exposed from the adhesive layer 45, with the diffusion layer 73 interposed therebetween. Then, the substrate 40 is fabricated.

Next, as shown in FIG. 12, the substrate 40 is disposed to face the liquid crystal display panel 12. At this time, the substrate 40 is disposed such that the third extension 33a of the second sub-FPC 33 of the light source unit 50 faces the second extension 30b of the main FPC 30. In vacuum environment, the adhesive layer 45 attaches the substrate 40 to the liquid crystal display panel 12.

Then, as shown in FIG. 13, the liquid crystal display panel 12, which is attached to the substrate 40, is attached to the back light unit 13 connected to the first sub-FPC 32. At this time, the back light unit 13 is assembled to the liquid crystal display panel 12 such that the fourth extension 32a of the first sub-FPC 32 of the back light unit 13 faces the first extension 30a of the main FPC 30.

After that, as shown in FIGS. 14 and 15, the first extension 30a of the main FPC 30 is electrically connected to the fourth extension 32a of the first sub-FPC 32 of the back light unit 13 by soldering, etc. As a result, as shown in FIG. 15, the electrical connecting portions 56 are formed in the first extension 30a and the fourth extension 32a by soldering, etc.

On the other hand, as shown in FIGS. 14 and 16, the second extension 30b of the main FPC 30 is electrically connected to the third extension 33a of the second sub-FPC 33 of the light source unit 50 by soldering, etc. As a result, as shown in FIG. 16, the electrical connecting portions 56 are formed in the second extension 30b and the third extension 33a by soldering, etc.

Next, as shown in FIGS. 17 and 18, the first and fourth extensions 30a and 32a, which extend outward from the side region 5 of the layered panel 10 along the short sides of the panels 12 and 13 at the side region 5, and are laminated and electrically connected together, are folded to the side region 5 of the layered panel 10. Similarly, the second and third extensions 30b and 33a are folded to the side region 5 of the layered panel 10.

Then, as shown in FIG. 19, the folded first and fourth extensions 30a and 32a and the folded second and third extensions 30b and 33a are attached and fixed to the main FPC 30 with the insulating tape material 55. As such, the liquid crystal display system 1 is manufactured.

### Advantages of First Embodiment

As described above, according to the first embodiment, the illumination light supplied from the light source unit 50 lights the control sections 4. This facilitates visual recognition of the control sections 4, even when the illuminance is relatively low under the use environment. As a result, the controllability of the liquid crystal display system 1 largely improves. In addition, the plurality of light emitting regions 64 with the optical patterns 63 are formed on the front surface 51b of the light guide plate 51 to be separated from one another. As a result, the light incident on the light guide plate 51 from the side surface 51a of the light guide plate 51 is efficiently emitted from the light emitting regions 64. Thus, even when the thickness of the light guide plate 51 of the light source unit 50 is reduced, the plurality of the control sections 4 corresponding to the light emitting regions 64 are reliably lighted, and the luminance of the light in the control sections 4 improves.

The light of the LEDs 74 is incident on the light guide plate 51 from the both ends of the band-like light guide plate 51. Even when the thickness of the light guide plate 51 is reduced, sufficient light is incident on the light guide plate 51, thereby improving the luminance of the light in the light emitting regions 64.

The step portion 7 is formed at the side of the liquid crystal display panel 12 and the side of the adhesive layer 45, and part of the light source unit 50 overlaps the liquid crystal display panel 12 in the step portion 7. As a result, the light source unit 50 is disposed in the liquid crystal display system 1 while reducing an increase in the width of the non-display section 3.

The light source unit 50 includes the LEDs 74 and the light guide plate 51, thereby lighting a wide area with a relatively small number of the LEDs 74. In addition, the thickness of the light source unit 50 is reduced, as compared to the case where a large number of light sources are arranged to directly emit illumination light to the control sections 4.

The light source unit 50 is disposed to overlap the driver IC 27 in the region where the second sub-FPC 33 has a relatively small thickness. This reduces the thickness of the non-display section 3, while reducing an increase in the width of the non-display section 3.

### Second Embodiment of Invention

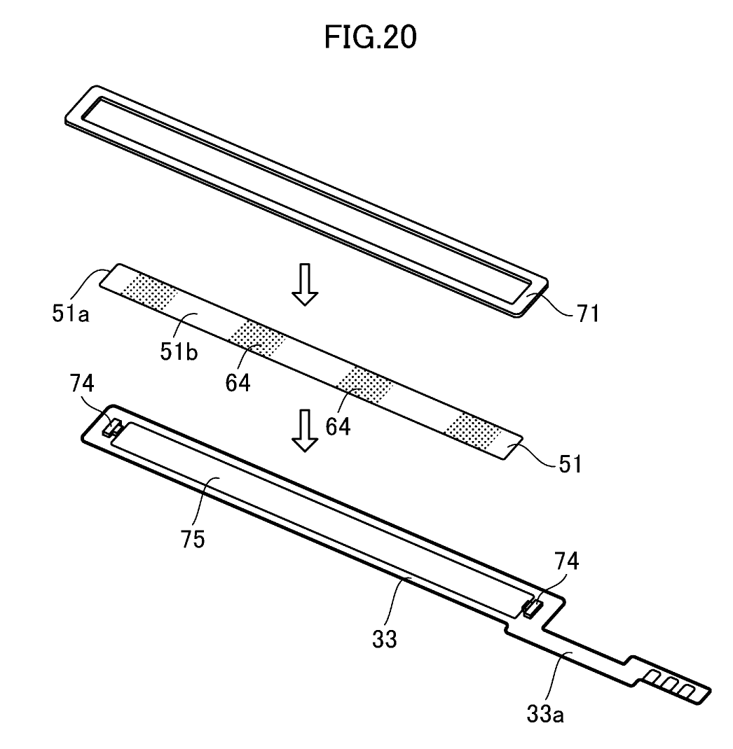

FIG. 20 illustrates a second embodiment of the present invention.

FIG. 20 is an oblique drawing of the structure of a light source unit 50 according to the second embodiment. In the following embodiments, the same reference characters as those shown in FIGS. 1-19 are used to represent equivalent elements, and the explanation thereof will be partially omitted.

In this second embodiment, the structure of the light source unit 50 according to the above-described first embodiment is partially modified. The other structures are similar to those in the first embodiment.

As shown in FIGS. 1 and 2, a liquid crystal display system 1 includes a layered panel 10 including a liquid crystal display panel 12 as a display panel, and a substrate 40 stacked on the layered panel 10.

As shown in FIG. 5, the liquid crystal display system 1 includes a display section 2 performing display with the liquid crystal display panel 12, and a non-display section 3 formed around the display section 2. As shown in FIG. 2, the substrate 40 is attached to the liquid crystal display panel 12 with an adhesive layer 45 interposed therebetween. The liquid crystal display system 1 has a step portion 7 including at least the side of the liquid crystal display panel 12 and the side of the adhesive layer 45 such that a space 6 is located in a part between the liquid crystal display panel 12 and the substrate 40.

The layered panel 10 includes the liquid crystal display panel 12, and a back light unit 13, which is a lighting device stacked on the liquid crystal display panel 12 to supply light to the display section 2. As shown in FIG. 2, the liquid crystal display panel 12 includes a TFT substrate 18, and a counter substrate 19 facing the TFT substrate 18.

The TFT substrate 18 has a short side region not facing the counter substrate 19. This short side region forms the above-described step portion 7. In this embodiment, the step portion 7 includes the side surface of the TFT substrate 18, the side surface of the counter substrate 19, and the side surface of the adhesive layer 45. A driver IC 27 and a main FPC 30 as circuit parts are connected to the short side region of the TFT substrate 18. The driver IC 27 includes a drive circuit driving and controlling the liquid crystal display panel 12.

As shown in FIG. 1, the substrate 40 includes a cover substrate 41, to which a protection film 42 is attached, and a touch panel 44 attached to the cover substrate 41 with a resin film 43 interposed therebetween. At the touch panel 44, the substrate 40 is attached to the liquid crystal display panel 12 of the layered panel 10 with the adhesive layer 45 interposed therebetween. As shown in FIG. 2, the substrate 40 has a side end portion 40a projecting more toward the side region 5 of the layered panel 10 than the layered panel 10.

The substrate 40 includes control sections 4 formed in the non-display section 3 of the liquid crystal display system 1 to input instructions to the touch panel 44. Specifically, a light shielding film (not shown) is formed on the cover substrate 41 at the side end portion 40a. As shown in FIG. 5, a plurality of icons as the control sections 4 are formed on the light shielding film using patterns transmitting light.

As shown in FIG. 2, the light source unit 50, which is for supplying illumination light to the control sections 4 to light the plurality of the control sections 4, is provided at the side end portion 40a of the substrate 40 separately and independently from the back light unit 13. At least part of the light source unit 50 is located in the space 6 between the substrate 40 and the liquid crystal display panel 12 to overlap the liquid crystal display panel 12 at the step portion 7.

As shown in FIG. 20, the light source unit 50 includes LEDs 74, which are light sources, a light guide plate 51 on which the light of the LEDs 74 is incident, a frame-like light shielding material 71 disposed around the light guide plate 51, and a second sub-FPC 33, which is a flexible substrate disposed on the light guide plate 51 at the side opposite to the side facing the substrate 40 to control the LEDs 74.

In the second sub-FPC 33 according to this embodiment, a reflection layer 75, which reflects to the light guide plate 51, the light emitted from the light guide plate 51 to the second sub-FPC, is printed on the region to be provided with the band-like light guide plate 51. The reflection layer 75 is, for example, a white or metallic colored layer, and formed by silkscreen printing, etc. Different from the first embodiment, the light source unit 50 according to this embodiment does not include the double-sided tape 72, thereby reducing the thickness as compared to the light source unit 50 according to the first embodiment.

The light shielding material 71 is disposed to surround the LEDs 74, the light guide plate 51, and the reflection layer 75, and attached to the second sub-FPC 33. The region of the second sub-FPC 33, which faces the driver IC 27 of the liquid crystal display panel 12, has a smaller thickness than the other regions. This avoids the contact between the second sub-FPC 33 and the driver IC 27.

As such, the light source unit 50 is controlled separately and independently from the back light unit 13, and supplies light to the icons, which are the control sections 4 formed on the side end portion 40a of the substrate 40, thereby lighting the control sections 4. When the user touches the lighting control sections 4, the touch positions are detected by the touch panel 44.

### Manufacturing Method

First, similar to the first embodiment, the cover substrate 41 is attached to the touch panel 44 with the resin film 43 interposed therebetween. Then, the adhesive layer 45 is attached to the touch panel, which is attached to the cover substrate 41. One short side region of the touch panel 44 is exposed from the adhesive layer 45 in the region, which serves as the side end portion 40a of the substrate 40.

On the other hand, as shown in FIG. 20, the reflection layer 75 is formed on the second sub-FPC 33 by silk-screen printing, etc. The LEDs 74 are mounted on the second sub-FPC 33. Then, the light guide plate 51 is disposed and fixed in the region printed with the reflection layer 75. The rectangular frame-like light shielding material 71 is attached to the second sub-FPC 33 to surround the LEDs 74, the light guide plate 51, and the reflection layer 75. The light source unit 50 is attached to the touch panel 44, which is exposed from the adhesive layer 45, with the diffusion layer 73 interposed therebetween. Then, the substrate 40 is fabricated.

Next, the substrate 40 is attached to the liquid crystal display panel 12 with the adhesive layer 45. Then, the liquid crystal display panel 12, which is attached to the substrate 40, is attached to the back light unit 13.

After that, the first extension 30a of the main FPC 30 is electrically connected to the fourth extension 32a of the first sub-FPC 32 of the back light unit 13 by soldering, etc. On the other hand, the second extension 30b of the main FPC 30 is electrically connected to the third extension 33a of the second sub-FPC 33 of the light source unit 50 by soldering, etc.

Then, the first and fourth extensions 30a and 32a and the second and third extensions 30b and 33a are folded to the side region 5 of the layered panel 10. Then, the folded first and fourth extensions 30a and 32a and the folded second and third extensions 30b and 33a are attached and fixed to the main FPC 30 with the insulating tape material 55. As such, the liquid crystal display system 1 is manufactured.

### Advantages of Second Embodiment

Similar to the above-described first embodiment, in this second embodiment, the illumination light supplied from the light source unit 50 lights the control sections 4. This facilitates visual recognition of the control sections 4, even when the illuminance is relatively low under the use environment. As a result, the controllability of the liquid crystal display system 1 largely improves. In addition, a plurality of light emitting regions 64 with optical patterns 63 are formed on a front surface 51b of the light guide plate 51 to be separated from one another. As a result, the light incident on the light guide plate 51 from a side surface 51a of the light guide plate 51 is efficiently emitted from the light emitting regions 64. Thus, even when the thickness of the light guide plate 51 of the light source unit 50 is reduced, the plurality of the control sections 4 corresponding to the light emitting regions 64 are reliably lighted, and the luminance of the light in the control sections 4 improves.

In addition, the light emitted from the light guide plate 51 toward the second sub-FPC 33 can be reflected by the reflection layer 75 of the second sub-FPC 33, and can be incident on the light guide plate 51 to be emitted toward the control sections 4, thereby efficiently utilizing the light of the LEDs 74. Furthermore, since the reflection layer 75 is directly printed on the second sub-FPC 33, there is no need to provide any particular reflection material for reflecting the light of the light guide plate 51. This reduces the thickness of the light source unit 50. As a result, the light source unit 50 is disposed in the space 6 between the liquid crystal display panel 12 and the substrate 40, while reducing expansion of the space 6.

### Third Embodiment of Invention

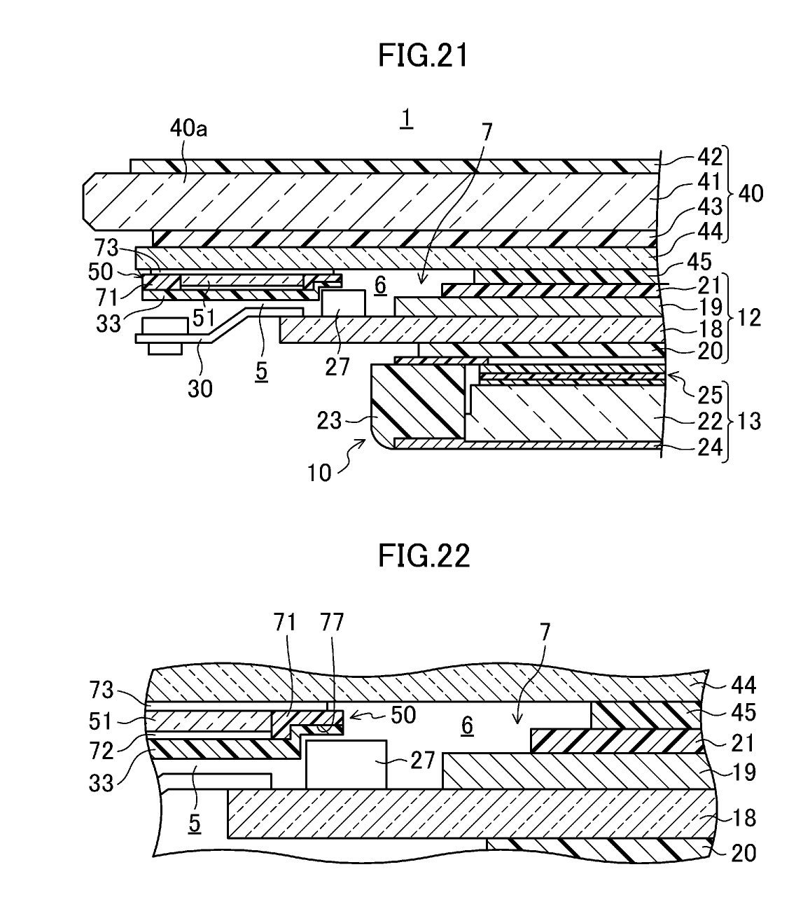

FIGS. 21 and 22 illustrate a third embodiment of the present invention.

FIG. 21 is an enlarged cross-sectional view illustrating the side of a liquid crystal display system 1 according to the third embodiment. FIG. 22 is an enlarged cross-sectional view illustrating part of FIG. 21.

In this third embodiment, the structure of the light source unit 50 according to the above-described first embodiment is partially modified. The other structures are similar to those in the first embodiment.

As shown FIG. 21, the liquid crystal display system 1 includes a layered panel 10 including a liquid crystal display panel 12 as a display panel, and a substrate 40 stacked on the layered panel 10.

As shown in FIG. 5, the liquid crystal display system 1 includes a display section 2 performing display with the liquid crystal display panel 12, and a non-display section 3 formed around the display section 2. As shown in FIG. 21, the substrate 40 is attached to the liquid crystal display panel 12 with an adhesive layer 45 interposed therebetween. The liquid crystal display system 1 has a step portion 7 including at least the side of the liquid crystal display panel 12 and the side of the adhesive layer 45 such that a space 6 is located in a part between the liquid crystal display panel 12 and the substrate 40.

The layered panel 10 includes the liquid crystal display panel 12, and a back light unit 13, which is a lighting device stacked on the liquid crystal display panel 12 to supply light to the display section 2. As shown in FIG. 21, the liquid crystal display panel 12 includes a TFT substrate 18, and a counter substrate 19 facing the TFT substrate 18.

The TFT substrate 18 has a short side region not facing the counter substrate 19. This short side region forms the above-described step portion 7. In this embodiment, the step portion 7 includes the side surface of the TFT substrate 18, the side surface of the counter substrate 19, and the side surface of the adhesive layer 45. A driver IC 27 and a main FPC 30 as circuit parts are connected to the short side region of the TFT substrate 18.

As shown in FIG. 21, the substrate 40 includes a cover substrate 41, to which a protection film 42 is attached, and a touch panel 44 attached to the cover substrate 41 with a resin film 43 interposed therebetween. At the touch panel 44, the substrate 40 is attached to the liquid crystal display panel 12 of the layered panel 10 with the adhesive layer 45 interposed therebetween. As shown in FIG. 21, the substrate 40 has a side end portion 40a projecting more toward the side region 5 of the layered panel 10 than the layered panel 10

The substrate 40 includes control sections 4 formed in the non-display section 3 of the liquid crystal display system 1 to input instructions to the touch panel 44. Specifically, a light shielding film (not shown) is formed on the cover substrate 41 at the side end portion 40a. As shown in FIG. 5, a plurality of icons as the control sections 4 are formed on the light shielding film using patterns transmitting light.

As shown in FIG. 21, the light source unit 50, which is for supplying illumination light to the control sections 4 to light the plurality of the control sections 4, is provided at the side end portion 40a of the substrate 40 separately and independently from the back light unit 13. At least part of the light source unit 50 is located in the space 6 between the substrate 40 and the liquid crystal display panel 12 to overlap the liquid crystal display panel 12 at the step portion 7.

As shown in FIGS. 21 and 4, the light source unit 50 includes LEDs 74, which are light sources, a light guide plate 51 on which the light of the LEDs 74 is incident, a frame-like light shielding material 71 disposed around the light guide plate 51, and a second sub-FPC 33, which is a flexible substrate disposed on the light guide plate 51 at the side opposite to the side facing the substrate 40 to control the LEDs 74.

The light guide plate 51 is formed like a band, disposed to extend along the short sides of the substrate 40, and attached to the second sub-FPC 33 with a white double-sided tape 72 interposed therebetween, which is a reflection material. The double sided tape 72 is formed by providing adhesive layers on the both surfaces of a white sheet material, and has the same band-like shape as the light guide plate 51. The LEDs 74 are disposed at the both ends of the light guide plate 51 to be mounted on the second sub-FPC 33.

The light shielding material 71 is disposed to surround the LEDs 74, the light guide plate 51, and the double-sided tape 72, and attached to the second sub-FPC 33. As shown in FIG. 22, the light shielding material 71 according to this embodiment has a cutout portion 77. The cutout portion 77 is formed at the outer edge of the light shielding material 71. Thus, the thickness of the light shielding material 71 is smaller at the cutout portion 77 than at the other portions. The light source unit 50 is disposed such that the cutout portion 77 of the light shielding material 71 overlaps part of the driver IC 27.

The second sub-FPC 33 is attached to the surface of the light shielding material 71, which is opposite to the surface facing the touch panel 44. The region of the second sub-FPC 33, which faces the driver IC 27 of the liquid crystal display panel 12, has a smaller thickness than the other regions. The portion of the second sub-FPC 33 with the small thickness is provided at the cutout portion 77. This avoids the contact between the light shielding material 71 and the second sub-FPC 33, and between the light shielding material 71 and the driver IC 27.

As such, the light source unit 50 is controlled separately and independently from the back light unit 13, and supplies light to the icons, which are the control sections 4 formed on the side end portion 40a of the substrate 40, thereby lighting the control sections 4. When the user touches the lighting control sections 4, the touch positions are detected by the touch panel 44.

### Manufacturing Method

First, similar to the first embodiment, the cover substrate 41 is attached to the touch panel 44 with the resin film 43 interposed therebetween. Then, the adhesive layer 45 is attached to the touch panel, which is attached to the cover substrate 41. One short side region of the touch panel 44 is exposed from the adhesive layer 45 in the region, which serves as the side end portion 40a of the substrate 40.

On the other hand, as shown in FIG. 4, the light guide plate 51 is attached to the second sub-FPC 33 mounted with the LEDs 74 with the white double sided tape 72 interposed therebetween. The rectangular frame-like light shielding material 71 is attached to the second sub-FPC 33 to surround the LEDs 74, the light guide plate 51, and the double-sided tape 72. As shown in FIG. 21, the light source unit 50 is attached to the touch panel 44, which is exposed from the adhesive layer 45, with the diffusion layer 73 interposed therebetween. Then, the substrate 40 is fabricated.

Next, the substrate 40 is attached to the liquid crystal display panel 12 with the adhesive layer 45. Then, the liquid crystal display panel 12, which is attached to the substrate 40, is attached to the back light unit 13.

After that, the first extension 30a of the main FPC 30 is electrically connected to the fourth extension 32a of the first sub-FPC 32 of the back light unit 13 by soldering, etc. On the other hand, the second extension 30b of the main FPC 30 is electrically connected to the third extension 33a of the second sub-FPC 33 of the light source unit 50 by soldering, etc.

Then, the first and fourth extensions 30a and 32a and the second and third extensions 30b and 33a are folded to the side region 5 of the layered panel 10. Then, the folded first and fourth extensions 30a and 32a and the folded second and third extensions 30b and 33a are attached and fixed to the main FPC 30 with the insulating tape material 55. As such, the liquid crystal display system 1 is manufactured.

### Advantages of Third Embodiment

Similar to the above-described first embodiment, in this third embodiment, the illumination light supplied from the light source unit 50 lights the control sections 4. This facilitates visual recognition of the control sections 4, even when the illuminance is relatively low under the use environment. As a result, the controllability of the liquid crystal display system 1 largely improves. In addition, a plurality of light emitting regions 64 with optical patterns 63 are formed on a front surface 51b of the light guide plate 51 to be separated from one another. As a result, the light incident on the light guide plate 51 from a side surface 51a of the light guide plate 51 is efficiently emitted from the light emitting regions 64. Thus, even when the thickness of the light guide plate 51 of the light source unit 50 is reduced, the plurality of the control sections 4 corresponding to the light emitting regions 64 are reliably lighted, and the luminance of the light in the control sections 4 improves.

In addition, the light source unit 50 is disposed such that the cutout portion 77 formed in the light shielding material 71 of the light source unit 50 overlaps part of the driver IC 27. This shuts out the light leaking from the light guide plate 51 using the light shielding material 71, while avoiding the contact between the driver IC 27 and the light source unit 50. The light source unit 50 is disposed to overlap the driver IC 27 to reduce the thickness of the non-display section 3, while reducing an increase in the width of the non-display section 3.

### Other Embodiments

In the above-described first to third embodiments, an example has been described where the layered panel 10 includes the liquid crystal display panel 12 and the back light unit 13. The layered panel 10 may include other panels such as a parallax barrier panel. In this case, the step portion 7 is formed by the side of the liquid crystal display panel 12, the side of the parallax barrier panel, and the side of the adhesive layer 45. The light source unit 50 is disposed at the step portion 7, thereby providing advantages similar to those in the above-described first to third embodiments.

While in the above-described third embodiment, an example has been described where the light source unit 50 includes the double sided tape 72, the reflection layer 75 may be printed on the second sub-FPC 33 as in the second embodiment.

While the liquid crystal display system 1 has been described in the above-described embodiments, the present invention is not limited thereto. The present invention is applicable to other display systems such as organic EL display systems, etc., including an organic EL display panel as the display panel.

While in the above-described first to third embodiments, an example has been described where the light shielding film is formed on the cover substrate 41 at the side end portion 40a of the substrate 40, and the plurality of the control sections 4 transmitting light are formed on the light shielding film. The light shielding film includes a film almost completely shutting out the incident light, and a film shutting out part of the incident light and transmitting some other type of light.

The present invention is not limited to the above-described first to third embodiments. The present invention includes configurations obtained by combining the first to third embodiments as appropriate.

### INDUSTRIAL APPLICABILITY

As described above, the present invention is useful for, for example, thin display systems such as liquid crystal display systems.

### DESCRIPTION OF REFERENCE CHARACTERS

1 Liquid Crystal Display System
2 Display Section
3 Non-Display Section
4 Control Section
12 Liquid Crystal Display Panel
33 Second Sub-FPC (Flexible Substrate)
40 Substrate
44 Touch Panel
50 Light Source Unit (Lighting Device)
51 Light Guide Plate
51a Side Surface
51b Front Surface
63 Optical Pattern
64 Light Emitting Region
74 LED (Light Source)
75 Reflection Layer

1. A lighting device comprising:
a light source;
a light guide plate including a side surface, on which light of the light source is incident, and a front surface extending perpendicular to the side surface; and
a plurality of light emitting regions disposed on the front surface to be spaced apart from one another, and having optical patterns for emitting light from an inside of the light guide plate.

2. The lighting device of claim 1, further comprising:
a flexible substrate disposed on the light guide plate at a side opposite to the front surface to control the light source, wherein
a reflection layer reflecting toward the light guide plate, light emitted from the light guide plate to the flexible substrate is printed on the flexible substrate.

3. The lighting device of claim 1, wherein
the light guide plate is formed like a band, and
the light source is disposed at each longitudinal end of the band-like light guide plate.

4. A display system comprising:
a display panel;
a display section performing display with the display panel;
a non-display section formed around the display section;
a substrate stacked on the display panel, and including a touch panel and a control section formed in the non-display section to input instructions to the touch panel; and
a lighting device for supplying illumination light to the control section to light the control section, wherein
the lighting device includes
a light source,
a light guide plate including a side surface, on which light of the light source is incident, and a front surface extending perpendicular to the side surface; and
a plurality of light emitting regions disposed on the front surface to be spaced apart from one another, and having optical patterns for emitting light from an inside of the light guide plate.

5. The display system of claim 4, wherein
the lighting device includes a flexible substrate disposed on the light guide plate at a side opposite to the front surface to control the light source, wherein
a reflection layer reflecting toward the light guide plate, light emitted from the light guide plate to the flexible substrate is printed on the flexible substrate.

6. The display system of claim 5, wherein
the light guide plate is formed like a band, and
the light source is disposed at each longitudinal end of the band-like light guide plate.
